(19) United States
(12) Patent Application Publication
(10) Pub. No.: US 2026/0022070 A1
(43) Pub. Date: Jan. 22, 2026

(54) USE OF ADDITIVES IN COMPOSITIONS OF PERVIOUS CONCRETE

(71) Applicant: Amrize Technology Switzerland LLC, ZUG (CH)

(72) Inventors: Isabelle DUBOIS BRUGGER, HOLDERBANK (CH); Quoc Huy VU, HOLDERBANK (CH)

(21) Appl. No.: 18/995,556

(22) PCT Filed: Jul. 21, 2023
(86) PCT No.: PCT/EP2023/070343

§ 371 Date: Jan. 16, 2025

(30) Foreign Application Priority Data
Jul. 21, 2022 (EP) 22306092.2

(51) Int. Cl. C04B 28/04; C04B 16/06; C04B 103/00; C04B 103/30; C04B 103/44

(52) U.S. Cl. CPC C04B 28/04; C04B 16/0633; C04B 2103/0051; C04B 2103/304; C04B 2103/44

(57) ABSTRACT

A method includes providing additives including a stabiliser and microfibres in pervious concrete compositions to increase their durability, wherein the stabiliser is a viscosity modifying agent as defined in the standard NF EN 934-2+A1:2012, and the pervious concrete has a porosity between 15% to 35%, by volume of the volume of hardened concrete.

The present invention relates to the use of additives in compositions of pervious concrete, to a method of preparing a pervious concrete, and to resulting construction elements.

Pervious concrete is a type of concrete used most often for flatwork applications that allows water from precipitation and other sources to flow through. The interest for such concrete compositions has been growing in the past decades, mainly as the use of this type of concrete in urban areas allows the recharge of groundwater. Furthermore, in case of sudden high amounts of rainfall in urban areas, the use of pervious concrete reduces the amount of water that needs to be evacuated. Hence the runoff from paved areas is reduced, which reduces the need for separate stormwater retention ponds and allows the use of smaller capacity storm sewers.

Pervious concrete is characterised by a high porosity, where large pores are interconnected, creating a network of cavities throughout the volume of pervious concrete, and through which water can flow.

An example of pervious concrete is described in WO2012/001292, in which a concrete composition which can more easily be placed while still fresh. In this disclosure, it is also indicated that pervious concrete preferentially has a porosity between 15% and 35%, preferably between 20% and 35%, in volume of the volume of hardened pervious concrete to effectively allow water to flow through.

As the porosity of pervious concrete is high, in damp conditions, there can be a significant amount of stagnant water that remains within the volume of concrete. In winter conditions, and especially when temperatures oscillate below and above 0° C., this stagnant water freezes and thaws periodically. As the volume of water increases when freezing, this phenomenon results in rapid physical degradation of the pervious concrete. This degradation is known to be accelerated when additional salts are present, such as de-icing salts. The capacity of the pervious concrete to let water flow through, and the durability of any construction element that integrates pervious concrete can then be significantly reduced, especially when used in cold climates where temperatures regularly oscillate to below and above 0° C. in repetitive freeze-thaw cycles.

There is therefore a need to increase the durability of pervious concrete for it to have a maximum life span when used in cold climates.

CN108329003 discloses a pervious concrete capable of effectively resisting freeze-thaw damage, which comprises the following raw materials: 470-520 kg of cement, 1300-1600 kg of coarse aggregate, 100-140 kg of water, 30-80 kg of mineral powder, 40-110 kg of silica fume, 4-5 kg of water reducing agent, 3-5 kg of hydrophobic agent and 20-60 kg of organic fibre.

CN113651575 discloses a preparation method of high-durability permeable concrete made of iron tailings and waste rocks. CN113651575 also teaches that the use of specific additives, namely air entraining agents, water reducers, and polypropylene fibres are effective at increasing the durability of pervious concrete. The air entrainer disclosed is a rosin resin or fatty alcohol sulfonate.

U.S. Pat. No. 10,919,807 relates to high-strength flowable concrete compositions. Said compositions are useful as backfilling micro-or nanotrenches, especially for rapid utility micro-or nano-trench filling in streets and roadways. However, U.S. Pat. No. 10,919,807 does not relate to pervious concretes. U.S. Pat. No. 10,759,701 discloses a low-density, high-strength concrete composition, with a low weight-fraction of aggregate to total dry raw materials, obtained thanks to the use of a non-absorptive and closed-cell lightweight aggregate such as glass microspheres or copolymer polymer beads, or a combination thereof. This light-weight concrete composition has a reduced density, higher strengths, higher strength-to-weight ratios, and increased R-value, as well as improved crack resistance, impact-resistance, and fire resistance. It may be used essentially for manufacturing building parts (walls, building structures, architectural panels, concrete blocks, insulation. However, U.S. Pat. No. 10,759,701 does not relate to pervious concretes.

Pervious concrete compositions, due to their high porosity, are prone to specific durability issues, arising from poor resistance to freeze-thaw cycles, or exposure to de-icing salts that creates salt scaling of concrete surfaces. The concrete compositions disclosed in

U.S. Pat. No. 10,919,807 and U.S. Pat. No. 10,759,701 are designed to be used in applications where such durability issues do not occur (backfilling for U.S. Pat. No. 10,919,807 and general structural concrete in U.S. Pat. No. 10,759,701).

It was found that the use of specific additives in pervious concrete significantly increases the durability of pervious concrete, especially in cold climates where concrete durability is affected by the freezing and thawing of water, and by exposure to de-icing salts used on roads in winter.

### DESCRIPTION OF THE FIGURES

FIG. 1: evolution of mass (%) of mix 1, mix 2, mix 3 or mix 4 submitted to 24-hour freeze thaw cycles during 21 days

FIG. 2: evolution of dynamic modulus (%) of mix 1, mix 2, mix 3 or mix 4 submitted to 24-hour freeze thaw cycles during 21 days

FIG. 3: mass loss after 28 cycles (kg/m²) of mix 1, mix 11, mix 8, mix 9, mix 10 and mix 12 (from left to right).

FIG. 4: evolution of splitting strength (%) of mix 1, mix 1, mix 13 or mix 14 submitted to 24-hour freeze thaw cycles during 21 days

The object of the invention is the use of a combination of a stabiliser and microfibres, in pervious concrete compositions to increase their durability, especially when the pervious concrete is subjected to freeze-thaw cycles. Accordingly, additives comprising stabiliser and microfibres are used in pervious concrete compositions to increase their durability.

In particular, it was found that this use improves the durability of pervious concrete compositions in cold climates, in comparison to known solutions based on the use of silica fume or metakaolin.

In an embodiment, the stabiliser is a viscosity modifying agent as defined in the standard NF EN 934-2+A1:2012. However, as used herein, the term stabiliser preferably does not include swelling or non-swelling clays.

In a preferred embodiment, the stabiliser is a viscosity modifying agent based on organic material such as modified polysaccharides (such as cellulose ether, starch ether, or guar ether), or acrylic polymers (such as ethoxylated urethane, alkali swellable emulsion, or copolymers of acrylic acid).

In an embodiment, the microfibres are polymeric microfibres, preferentially polypropylene microfibres. The microfibres preferably have a length comprised between 5 and 30 mm, more preferably 5 to 20 mm, and a diameter comprised between 1 to 50 micrometres, preferably 10 to 40 micrometres.

In an embodiment, the stabiliser is used at a dosage of 0.1 to 1.0%, preferably 0.3 to 0.8%, by mass of active ingredient of the mass of cement, and the microfibres are used at a dosage comprised between 0.1 and 0.6%, preferably between 0.1 and 0.3%, by mass of the mass of cement. For the sake of clarity, the mass of cement includes all constituents as defined in NF EN 197-1:2012.

In an embodiment, the pervious concrete comprises cement, aggregates, water, optionally sand, and wherein the cement is a Portland Cement. Compared to standard concrete, pervious concrete is prepared by making of concrete composition in which the total volume of cement, water and optionally sand, is not sufficient to fill all the voids that exist between the aggregates. It may in particular be prepared following the protocols of WO2012/001292.

The Portland Cement can be any cement described in the standard NF EN 197-1:2012, as well as any cement comprising Portland clinker and one or several constituents as defined in the same standard. These constituents can be granulated blast furnace slag(S), pozzolanic materials (P), fly ashes (V, W), burnt shale (T), limestone (L, LL), or silica fume.

In a preferred embodiment, the cement is a CEM I, CEM II, CEM III, a CEM IV or a CEM V.

In a preferred embodiment, the cement has a Blaine Surface of at least 3500 cm²/g, measured according to the standard EN 196-6:2018.

The composition of the pervious concrete is adjusted by adjusting the proportions of aggregates, cement, and water, so as to achieve a desired porosity, for example as described in WO2012/001292. Any known composition pervious concrete composition is suitable for this invention, however, a porosity comprised between 15% and 35%, preferably 20% to 35%, by volume of the volume of hardened is preferred so as to maximize the amount of water that can flow through a hardened pervious concrete.

In an embodiment, the pervious concrete, preferably the additives, further comprises a solid air entrainer. The solid air entrainer is a powder composed of solid hollow spheres having a size of (45±10) μm. The hollow spheres can be organic or inorganic. An example of organic solid air entrainer is the product Sika® Aer Solid, made from an acrylonitrile polymer. An example of an inorganic solid air entrainer is the product 3M Glass Bubbles, made from silica. Preferably the solid air entrainer is a polymeric air entrainer.

Solid air entrainer, even when used alone, improves the performance of pervious concrete compositions as shown in example. Solid air entrainer can be used as the sole additive in pervious concrete compositions to increase their durability, especially when subjected to freeze-thaw cycles, or in the combination with the stabiliser and the microfibres disclosed above.

In a preferred embodiment, the solid air entrainer is used at a dosage of 0.1 to 1.0%, preferably 0.1 to 0.8%, by mass of the mass of cement.

In an embodiment, the pervious concrete, preferably the additives, further comprises a super absorbent polymer (SAP).

SAPs are pulverulent crosslinked polymers capable of swelling by means of water or aqueous salt solutions to form a soft insoluble gel. SAPs are able to absorb at least 50, 100, 200, 300, 400 times their weight, in increasing order of preference, of liquids without release them again. Examples or SAPs are: crosslinked sodium polyacrylates; crosslinked sodium acrylamide and acrylate copolymers; crosslinked sodium acrylate or acrylamide copolymers.

In a preferred embodiment, the super absorbent polymer is used at a dosage of 0.1 to 0.8%, preferably 0.1 to 0.5%, by mass of the mass of cement.

The present invention also relates to a method of preparing a pervious concrete, wherein the pervious concrete comprises cement, water, aggregates, optionally sand, and additives, wherein the additives comprise stabiliser and microfibres as defined above.

In an embodiment of the method of preparing the pervious concrete, the additives are mixed with the cement prior to the preparation of the pervious concrete. In this embodiment, a pre-mixed cement is thus specially produced to be used for making pervious concrete of high durability.

In an embodiment of the method of preparing the pervious concrete, the additives are mixed together with all the other constituents of the pervious concrete, for example in a ready-mix concrete production plant.

In an embodiment of the method of preparing the pervious concrete, the additives further comprise a solid air entrainer and/or super absorbent polymer as defined above.

The present invention also relates to a construction element made from the pervious concrete obtained from this method of preparation. A preferred construction element for this invention is a concrete slab, used for example in urban areas such as car parks, cycle ways, or pavements.

The present invention also relates to a pre-mixed cement composition comprising cement, stabiliser, microfibres and solid air entrainer and/or super absorbent polymer. The additives and their preferred dosage in the pre-mixed cement composition are as disclosed above.

The invention is now illustrated in the following examples.

### EXAMPLES

In the following examples the pervious concrete mix compositions in the following table are used.

TABLE 1

| | | OPC | SF | MK | MF | SAE | S | SP | W | Agg |
|---|---|---|---|---|---|---|---|---|---|---|
| | | (kg) | (kg) | (kg) | (kg) | (kg) | (kg) | (kg) | (kg) | (kg) |
| Mix 1 | Reference | 245 | — | — | — | — | — | 2.3 | 71 | 1503 |
| | W/B = 0.29 | | | | | | | | | |
| Mix 2 | SF 4% | 235 | 10 | — | — | — | — | 3.2 | 71 | 1503 |
| | W/B = 0.29 | | | | | | | | | |
| Mix 3 | SF 10% | 220.5 | 24.5 | — | — | — | — | 4.3 | 71 | 1503 |
| | W/B = 0.29 | | | | | | | | | |
| Mix 4 | MK 10% | 220.5 | — | 24.5 | — | — | — | 3.7 | 71 | 1503 |
| | W/B = 0.29 | | | | | | | | | |
| Mix 5 | Reference | 242 | — | — | — | — | — | 1.5 | 82 | 1524 |
| | W/B = 0.34 | | | | | | | | | |
| Mix 6 | MK 10% | 270 | — | 30 | — | — | — | 0.7 | 102 | 1503 |
| | W/B = 0.34 | | | | | | | | | |
| Mix 7 | SF 10% | 270 | 30 | — | — | — | — | 0.5 | 102 | 1503 |
| | W/B = 0.34 | | | | | | | | | |
| Mix 8 | Solid air | 300 | — | — | — | 2 | — | 0.4 | 102 | 1503 |
| | entrainer | | | | | | | | | |
| | W/B 0.34 | | | | | | | | | |
| Mix 9 | microfibres | 314 | — | — | 0.9 | — | — | 0.3 | 109 | 1524 |
| | W/B 0.34 | | | | | | | | | |
| Mix 10 | Stabiliser | 314 | — | — | — | — | 1 | 0.3 | 109 | 1524 |
| | W/B 0.34 | | | | | | | | | |
| Mix 11 | Microfibres + | 314 | — | — | 0.9 | — | 1 | 0.3 | 109 | 1524 |
| | stabiliser | | | | | | | | | |
| | W/B 0.34 | | | | | | | | | |
| Mix 12 | Solid air | 310 | — | — | 0.9 | 2 | 1 | 0.4 | 109 | 1524 |
| | entrainer + | | | | | | | | | |
| | microfibres + | | | | | | | | | |
| | stabiliser | | | | | | | | | |
| | W/B 0.34 | | | | | | | | | |
| Mix 13 | Solid air | 245 | — | — | — | 0.49 | — | 2.3 | 71 | 1503 |
| | entrainer | | | | | | | | | |
| | W/B 0.29 | | | | | | | | | |
| Mix 14 | Liquid air | 245 | — | — | — | — | — | 2.3 | 71 | 1503 |
| | entrainer at 0.5% | | | | | | | | | |
| | of the mass of | | | | | | | | | |
| | OPC W/B 0.29 | | | | | | | | | |

OPC refers to the cement, which is here a CEM I 52.5N, an Ordinary Portland Cement.
SF refers to silica fume.
MK refers to metakaolin.
MF refers to the microfibres, here CHRYSO Fibre Syntec 12.
SAE refers to the solid air entrainer, here Sika AER Solid (hollow acrylonitrile polymer microspheres) (mixes 8, 12 and 13) or to a liquid air entrainer, Chryso Air D, in mix 14.
AEA refers to the classic liquid air entrainer, here CHRYSO ®Air D.
S refers to the stabiliser, here the powder MAPECRETE DRAIN P supplied by Mapei. MAPECRETE DRAIN P is a copolymer, and is a viscosity modifying agent.
SP refers to a water-reducing agent, here CHRYSO ®Fluid Optima 206.
W refers to the total amount of effective water, calculated by adding the mixing water with the water from the liquid admixtures, and deducting the water absorbed by the aggregates.
W/B refers to the mass ratio of water to binder, which is calculated by adding the mass of OPC, SF, MK and MF.
Agg refers to the aggregates, which have a size of 3 mm to 11 mm.

### Example 1—Durability of Pervious Concrete That Contains Silica Fume or Metakaolin

Four pervious concrete compositions were prepared:
Mix 1: a reference pervious concrete composition with a water with a W/B of 0.29,
Mix 2: a concrete pervious composition containing silica fume at a dosage of 4% of the mass of cement,
Mix 3: a concrete composition containing silica fume at a dosage of 10% of the mass of cement, and
Mix 4: A concrete composition containing metakaolin at a dosage of 10% of the mass of cement.

In order to measure the resistance of these concrete compositions under freeze thaw conditions, concrete specimens of 10×10×10 cm were prepared and cured for 28 days at 20° C. in a room having a relative humidity of 100%. After this curing step, their durability was tested in freeze-thaw cycles as follows:
The mass and dynamic modulus of the concrete specimens was first measured,
The specimens were fully immersed in a solution of sodium chloride of 3% of the mass of water and placed in a testing chamber, initially at a temperature of +10° C.,
For a total duration of 21 days, the samples were subjected to 24-hour freeze thaw cycles, where the temperature of the testing chamber is:
   first reduced from +10° C. to −20° C. at a rate of −5° C. per hour,
   then left at −20° C. for a duration of 4 hours,
   then increased again to a temperature of +10° C. at a rate of +5° C. per hour, and
   left at a temperature of +10° C. for the remaining duration of a 24-hour cycle.

The dynamic modulus is measured as described in the standard ASTM C597-16 using an ultrasonic apparatus (ULTRATEST BP-700 Pro).

During 21 days, changes in mass change and dynamic modulus were measured. Reductions in any of these values indicate a reduction of the durability of the concrete composition when subjected to freeze thaw cycles.

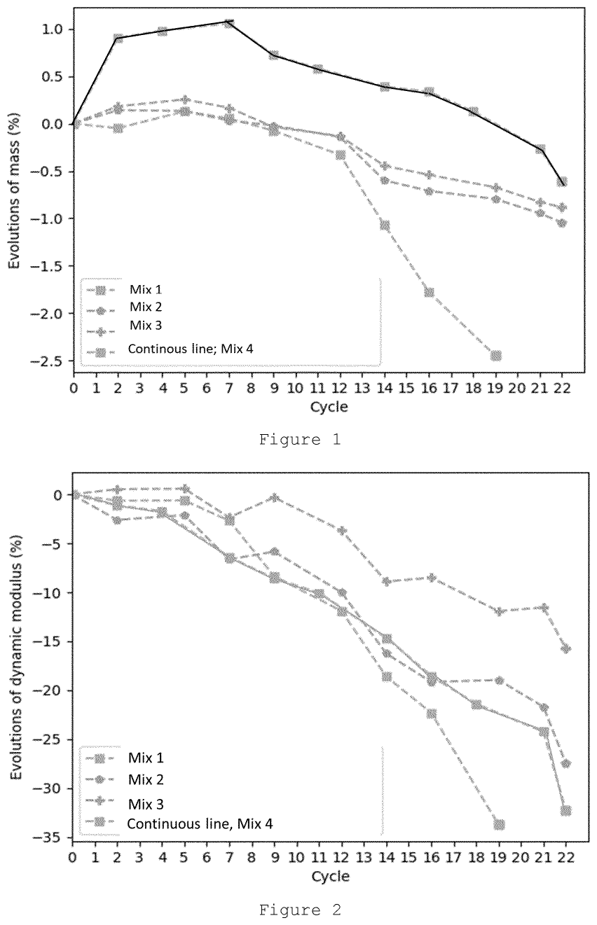

The results are reported in FIG. 1 and FIG. 2, and confirm that the use of silica fume and metakaolin both improve the durability of the corresponding concrete compositions when exposed to freeze thaw cycles. More precisely, in these tests, it was found that silica fume at a dosage of 10% of the mass of cement performed best, followed by silica fume at a dosage of 4% of the mass of cement, and finally followed by metakaolin at a dosage of 10% of the mass of cement.

Additional tests were carried out using a different freeze-thaw protocol. In these tests, concrete specimens were prepared and cured at 20° C. for a duration of 7 days in water followed by 20 days in a curing chamber at 65% relative humidity. After this curing step, their durability was tested in freeze-thaw cycles as follows:
The mass of the concrete specimens are first measured,
The lower part of the specimens were immersed, so as that 1 cm of the lower part remains in a solution of sodium chloride of 3% of the mass of water and placed in a testing chamber, initially at a temperature of +20° C.,
For a total duration of 14 days, the samples were subjected to 28 12-hour freeze thaw cycles, in which the temperature of the testing chamber is:
   first reduced from +20° C. to −20° C. at a rate of −10° C. per hour,
   then left at −20° C. for a duration of 3 hours,
   then increased again to a temperature of +20° C. at a rate of +10° C. per hour, and
   left at a temperature of +20° C. for the remaining duration of a 12-hour cycle.

After 28 freeze-thaw cycles, changes in mass are measured, and expressed in kg per m² of surface of immersed concrete specimens. Changes in mass of less than 1.5 kg/m² are synonymous with concrete compositions that have excellent durability when exposed to natural freeze-thaw conditions. As can be seen in the following table, none of the mixes passed the test, as the mass loss is higher than 1.5 kg/m².

TABLE 2

| | Mass loss after |
|---|---|
| Mix | 28 cycles (kg/m2) |
| Mix 1 - Reference W/B 0.29 | 4.7 |
| Mix 5 - Ref W/B 0.34 | >10 |
| Mix 6 - W/B = 0.34 - Metakaolin 10% | 62.1 |
| Mix 7 - W/B = 0.34 - Silica Fume 10% | 9.5 |

These results are consistent with those disclosed in earlier studies, and the concrete compositions disclosed in this first example are not according to the present invention.

### Example 2

Five pervious concrete compositions were prepared:
Mix 1: a reference concrete composition,
Mix 8: a concrete composition containing a solid air entrainer at a dosage of 0.7% of the mass of cement,
Mix 9: a concrete composition containing microfibres at a dosage of 0.3% of the mass of cement,
Mix 10: a concrete composition containing a stabiliser at a dosage of 0.3% of the mass of cement,
Mix 11: a concrete composition containing microfibres at a dosage of 0.3% of the mass of cement and stabiliser at a dosage of 0.3% of the mass of cement,
Mix 12: a concrete composition containing microfibres at a dosage of 0.3% of the mass of cement, stabiliser at a dosage of 0.3% of the mass of cement, and a solid air entrainer at a dosage of 0.3% of the mass of cement

Concrete specimens were prepared and cured at 20° C. for a duration of 7 days in water followed by 20 days in a curing chamber at 65% relative humidity. After this curing step, their durability was tested in freeze-thaw cycles as follows:
The mass of the concrete specimens are first measured,
The lower part of the specimens were immersed, so as that 1 cm of the lower part remains in a solution of sodium chloride of 3% of the mass of water and placed in a testing chamber, initially at a temperature of +20° C.,
For a total duration of 14 days, the samples were subjected to 12-hour freeze thaw cycles, in which the temperature of the testing chamber is:
first reduced from +20° C. to −20° C. at a rate of −10° C. per hour,
   then left at −20° C. for a duration of 3 hours,
   then increased again to a temperature of +20° C. at a rate of +10° C. per hour, and
   left at a temperature of +20° C. for the remaining duration of a 12-hour cycle.

After 14 days of freeze-thaw cycles, changes in mass are measured, and expressed in kg per m² of surface of immersed concrete. Changes in mass of less than 1.5 kg/m² are synonymous with concrete compositions that have excellent durability when exposed to natural freeze-thaw conditions.

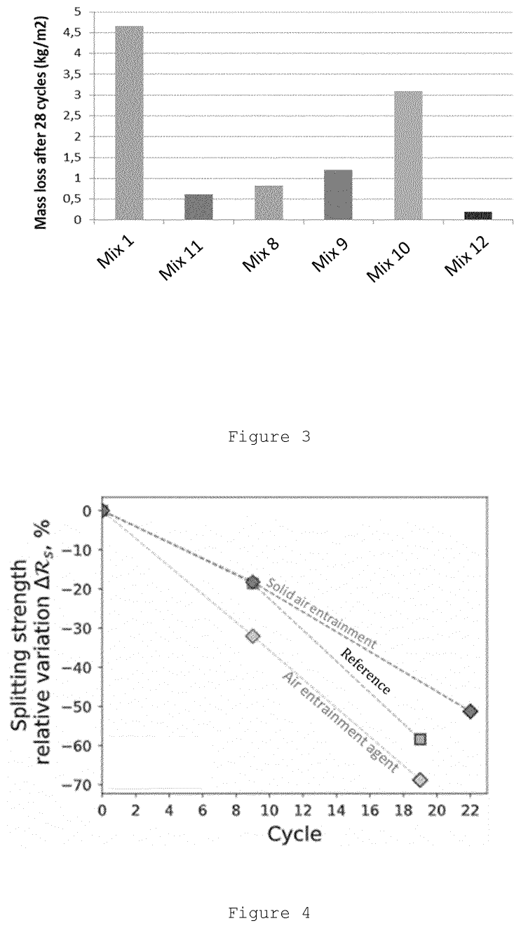

The results are presented in FIG. 3 and in the following table.

TABLE 3

| | Mass loss after |
|---|---|
| | 28 cycles (kg/m2) |
| Mix 1 - Ref W/B 0.29 | 4.66 |
| Mix 8 - Solid air entrainer | 0.82 |
| W/B 0.34 | |
| Mix 9 - Microfibres | 1.2 |
| W/B 0.34 | |
| Mix 10 - Stabiliser | 3.1 |
| W/B 0.34 | |
| Mix 11 - Microfibres + stabiliser | 0.62 |
| W/B 0.34 | |
| Mix 12 - Solid air entrainer + microfibres + stabiliser | 0.2 |
| W/B 0.34 | |

The use of either the solid air entrainer or microfibres reduces the mass loss after 28 cycles to a level which is already lower than the loss measured when silica fume or metakaolin are used (cf. example 1). The use of the stabiliser alone also reduces the mass loss, however the loss remains above the maximum desired value of 1.5 kg/m². The combined use of microfibres and the stabiliser reduces the mass loss after 28 freeze-thaw cycles significantly below the value of 1.5 kg/m², which corresponds to particularly high freeze-thaw resistances of the pervious concrete compositions. The combination of microfibres and stabiliser is much more efficient than each component taken separately, which demonstrates a synergistic effect between the two components.

The combination of the 3 components (microfibres, the stabiliser, and the solid air entrainer), results by far the best performing concrete compositions: the mass loss after 28 cycles is only 0.2 kg/m².

### Example 3—Comparison Solid vs. Liquid Air Entrainer

Three pervious concrete compositions were prepared:
Mix 1: a reference concrete composition,
Mix 13: a concrete composition containing a solid air entrainer at a dosage of 0.2% of the mass of cement (dosage recommended by manufacturer),
Mix 14: a concrete composition containing a liquid air entrainer at a dosage of 0.5% of the mass of cement (dosage recommended by manufacturer).

In order to measure the resistance of these concrete compositions under freeze thaw conditions, concrete specimens of 10×10×10 cm were prepared and cured for 28 days at 20° C. in a room having a relative humidity of 100%. After this curing step, their durability was tested in freeze-thaw cycles as follows:
The splitting strength of the concrete specimens was first measured,
The specimens were fully immersed in a solution of sodium chloride of 3% of the mass of water and placed in a testing chamber, initially at a temperature of +10° C.,
For a total duration of 21 days, the samples were subjected to 24-hour freeze thaw cycles, where the temperature of the testing chamber is:
   first reduced from +10° C. to −20° C. at a rate of −5° C. per hour,
   then left at −20° C. for a duration of 4 hours,
   then increased again to a temperature of +10° C. at a rate of +5° C. per hour, and
   left at a temperature of +10° C. for the remaining duration of a 24-hour cycle.

The splitting strength is measured as described in the standard BS 1881-117:1983.

During 21 days, changes in splitting strength was measured. Reductions in splitting strength indicate a reduction of the durability of the concrete composition when subjected to freeze thaw cycles.

The results are reported in FIG. 4. The use of solid air entrainment improves the durability of the corresponding concrete compositions when exposed to freeze thaw cycles. On the contrary, the use of a liquid air entrainer does not improve the durability of the corresponding concrete compositions when exposed to freeze thaw cycles: the performances are less good than those obtained with the reference. Of note, a liquid air entrainer contains water in quantities much higher than a solid air entrainer, while a solid air entrainer often further contains mineral carriers and anti-caking agents. Therefore, the content of air entrainer is not reflective of the actual content of “active air entrainer”. This explains why the results obtained with mixes 13 and 14 may be compared, even though the air entrainer concentration is different.

1. A method comprising providing additives comprising a stabiliser and microfibres in pervious concrete compositions to increase their durability, wherein the stabiliser is a viscosity modifying agent as defined in the standard NF EN 934-2+A1:2012, and the pervious concrete has a porosity comprised between 15% to 35%, by volume of the volume of hardened concrete.

2. The method according to claim 1, wherein the stabiliser is a viscosity modifying agent based on modified polysaccharides, or
acrylic polymers.

3. The method according to claim 1, wherein the microfibres are polymeric microfibres.

4. The method according to claim 1, wherein the microfibres have a length comprised between 5 and 30 mm and a diameter comprised between 1 to 50 micrometres.

5. The method according to claim 1, wherein the stabiliser is used at a dosage of 0.1 to 1.0% by mass of active ingredient of the mass of cement, and the microfibres are used at a dosage comprised between 0.1 and 0.6% by mass of the mass of cement.

6. The method Use according to claim 1, wherein the pervious concrete comprises cement, aggregates, water, and wherein the cement is a Portland Cement.

7. The method according to claim 1, wherein the pervious concrete has a porosity comprised between 20% to 35%, by volume of the volume of hardened concrete.

8. The method according to claim 1, wherein the additives further comprise a solid air entrainer.

9. The method according to claim 8, wherein the solid air entrainer is used at a dosage of 0.1 to 1.0%, by mass of the mass of cement.

10. The method according to claim 1, wherein the additives further comprise a super absorbent polymer.

11. A method of producing a pervious concrete, wherein the pervious concrete comprises cement, water, aggregates, and additives, wherein the additives are as defined in claim 1.

12. The method of producing a pervious concrete according to claim 11, wherein the additives are mixed with the cement, so as to obtain a pre-mixed cement composition, prior preparing the pervious concrete.

13. The method of producing a pervious concrete according to claim 11, wherein the additives are added during the preparation of the pervious concrete together with the water.

14. A construction element obtained by the method of claim 11.

15. A pre-mixed cement composition comprising cement and the additives as defined in claim 8.

16. The method according to claim 1, wherein the stabiliser is a viscosity modifying agent based on cellulose ether, starch ether, guar ether.

17. The method according to claim 1, wherein the stabiliser is a viscosity modifying agent based on ethoxylated urethane, alkali swellable emulsion, or copolymers of acrylic acid.

18. The method according to claim 1, wherein the microfibres are polypropylene microfibres.

19. The method according to claim 1, wherein the additives further comprise a polymeric solid air entrainer.
